(19) United States
(12) Patent Application Publication
(10) Pub. No.: US 2019/0070670 A1
(43) Pub. Date: Mar. 7, 2019

(54) ADJUSTABLE CUTTING SURFACE BORING BAR HEAD

(71) Applicant: Energy, United States Department of, Washington, DC (US)

(72) Inventors: WILLIAM D. FUGER, IDAHO FALLS, ID (US); SPENCER C. WENDEL, NORTH LOGAN, UT (US)

(21) Appl. No.: 16/181,400

(22) Filed: Nov. 6, 2018

Related U.S. Application Data
(63) Continuation-in-part of application No. 15/622,175, filed on Jun. 14, 2017.

(51) Int. Cl. B23B 29/034

(52) U.S. Cl. CPC B23B 29/03407

(57) ABSTRACT

A boring bar head body is disclosed. An example boring bar head includes a front face, an attachment face opposed to the front face, and an axis substantially perpendicular to the front face and attachment face. The attachment face is operably connected to a boring bar. The front face includes a low plane, a high plane, and an insert groove in between at least a portion of the high and low planes. In the insert groove there is at least one cutting insert that has a cutting surface and a bottom surface. The cutting insert is removably attached to the insert groove.

### RELATED APPLICATIONS

This application is a continuation in part of copending U.S. patent application Ser. No. 15/622,175 filed Jun. 14, 2017.

### STATEMENT OF GOVERNMENT SUPPORT

The United States Government has rights in this invention pursuant to Contract No. DE-AC07-05ID14517 between the U.S. Department of Energy (DOE) and Battelle Energy Alliance LLC.

### TECHNICAL HELD

This disclosure generally relates to boring bar heads used for machining holes. More specifically, the presented embodiments relate to an adjustable boring bar head used for machining deep holes with a closed and flat bottom.

### BACKGROUND

Machining deep and flat bottomed holes is a difficult and cumbersome process. Drill shafts used for deep holes lack rigidity, causing the drill shaft to vibrate. The vibrations cause a rough finish and the bottom of the hole may not be smooth. For deep holes, bore heads can be used due to their increased rigidity. However, bore heads interfere with cutting the center of the hole, leaving a hump or conical shape in the center of the deep hole because the bore head can drill the perimeter of the bottom of a deep hole but not the center of the bottom of a deep hole. Therefore, there is a need for machining a deep hole with a closed and flat bottom.

### SUMMARY OF THE INVENTION

According to one aspect of the invention, a boring bar head body has a front face, an attachment face opposed to the front face, and an axis substantially perpendicular to the front face and attachment faces. The attachment face is operably connected to a boring bar. The front face has a low plane, a high plane, an insert groove in between at least a portion of the high and low planes, and at least one cutting insert disposed in the insert groove. The high and low planes are disposed substantially orthogonal to the axis. The boring bar head has a first length and a second length. The at least one cutting insert has a cutting surface and a bottom surface. The cutting insert is removably attached to the insert groove. The cutting surface extends to a third length.

### BRIEF DESCRIPTION OF THE DRAWINGS

Embodiments of the present invention are illustrated in the accompanying figures where:

FIG. 1 is a top isometric view of the boring bar head according to an embodiment the invention;

FIG. 2 is a section view of the boring bar head according to an embodiment of the invention;

FIG. 3 is a section view of the boring bar head according to an embodiment of the invention;

FIG. 4 is a section view of the boring bar head according to an embodiment of the invention;

FIG. 5A is a plan view of a cutting path of a typical prior art boring bar head;

FIG. 5B is a plan view of the concentric circles created with one rotation of a typical prior art boring bar head;

FIG. 5C is a plan view of the concentric circles created with multiple rotations of a typical prior art boring bar head that do not reach both the perimeter and center of the deep hole;

FIG. 6A is a plan view of a cutting path of an embodiment of the present invention's boring bar head;

FIG. 6B is a plan view of the concentric circles created with one rotation of an embodiment of the present invention's boring bar head;

FIG. 6C is a plan view of the concentric circles created with multiple rotations of an embodiment of the present invention's boring bar head that reach the perimeter and center of the deep hole;

FIG. 7 is a side isometric view of the boring bar head according to an embodiment the invention; and

FIG. 8 is a top isometric view of the boring bar head according to an embodiment the invention.

### DETAILED DESCRIPTION

While the present invention may be embodied in many different forms, disclosed herein are specific illustrative embodiments thereof that exemplify the principles of the invention. It should be emphasized that the present invention is not limited to the specific embodiments illustrated.

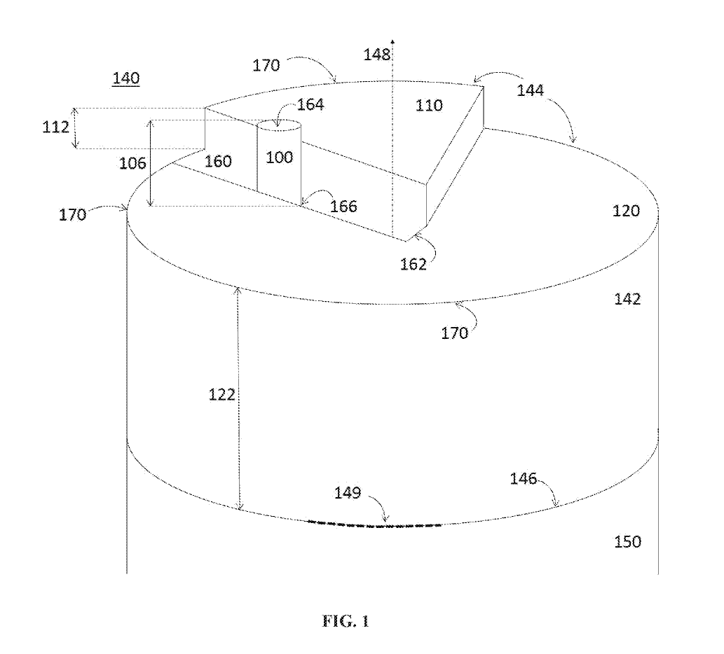

The present invention generally relates to a boring bar head 140 for machining a deep hole with a closed and flat bottom. Referring to FIG. 1, the boring bar head 140 has a body 142. The boring bar head body 142 has a front face 144, an attachment face 146 opposed to the front face 144, and an axis 148. The axis 148 is the center of rotation of the boring bar head 140. In an embodiment the axis 148 is substantially perpendicular to the front face 144 and attachment face 146.

The attachment face 146 is removably attached to a boring bar 150 through connection means 149. Removably attached means the attachment face 146 is secured to the boring bar 150 through connection means 149 in a way that allows for unlimited connection, disconnection, and repositioning of the attachment face 146 to the boring bar 150. In an embodiment, the connection means 149 is a dial screw. In another embodiment, the connection means 149 is a dovetail joint.

A boring bar 150 is a tool used in metalworking for boring or enlarging and shaping pre-drilled holes. Typically, boring bar heads 140 are used to bore holes into metal pieces. A boring bar 150 may have several boring bar head bodies 142 connected to it. Different boring bar head bodies 142 perform different functions including, but not limited to, cooling, roughing, shaping, and smoothening. Different boring bar head bodies 142 allow different types of holes to be bored or finished into metal pieces. The holes that are bored can vary in size, shape, depth, and surface finishes.

The front face 144 has a low plane 120, a high plane 110, an insert groove 160, and at least one cutting insert 100. The low plane 120 and the high plane 110 are two surfaces that create the foundation of the front face 144. The low plane 120 and the high plane 110 may be disposed at different distances from the attachment face 146. In an embodiment, the low plane 120 and the high plane 110 of the front face 144 are substantially perpendicular to the axis 148. In an embodiment, the low plane 120 is parallel to the high plane 110. The high plane 110 has a first length 112 that is measured as the distance between the highest point of the low plane 120 and the highest point of the high plane 110. The low plane 120 has a second length 122 that is measured as the distance between the lowest point of the attachment face 146 and the highest point of the low plane 120. In an embodiment, as shown in FIG. 1, the first length 112 is shorter than the second length 122. In another embodiment, the first length 112 is equal to zero, meaning the highest point of the low plane 120 and the highest point of the high plane 110 are equal.

The insert groove 160 is between at least a portion of the high plane 110 and at least a portion of the low plane 120. The insert groove 160 extends radially inward toward the axis 148 beginning at or near a perimeter edge 170. The perimeter edge 170 is the edge surrounding the front face 144. In an embodiment, the insert groove 160 begins on the perimeter edge 170. In another embodiment, the insert groove 160 begins at a point inside the perimeter edge 170. The insert groove 160 can intersect the axis 148 or bypass the axis 148 along a chord. A chord is a line segment that spans two points on the perimeter edge 170 without intersecting the axis 148. The insert groove 160 extends radially toward the axis 148 and ends at the insert groove end point 162 beyond the axis 148. The insert groove 160 is sized to receive at least one cutting insert 100.

The at least one cutting insert 100 is removably attached to the insert groove 160. Removably attached means the at least one cutting insert 100 is secured within the insert groove 160 in a way that allows for unlimited connection, disconnection, and repositioning of the at least one cutting insert 100 within the insert groove 160. Unlike prior art boring bar heads that have integrated cutting inserts permanently attached to the boring bar head, the removeably attached cutting insert 100 can be connected, disconnected, and repositioned within the insert groove 160 to allow for the machining of deep, flat bottomed holes without multiple machining parts. In prior art boring bar heads, when machining a deep, flat bottomed hole, one boring bar head is unable to machine the perimeter and the center of the hole. In the present invention, the cutting insert 100 can be disconnected and repositioned on the same boring bar head to machine the perimeter and the center of the hole. Unlike prior art methods, the cutting insert 100 is not an integrated piece of the front face 144. The at least one cutting insert 100 is removably secured in a way that causes a closed and flat hole to be bored. In an embodiment, one cutting insert 100 is used to bore a deep flat bottomed hole by disconnecting and repositioning the cutting insert 100 in the insert groove 160. In another embodiment, there are two or more cutting inserts 100 removably attached to the insert groove 160 positioned to cause a flat hole to be bored. Therefore, the at least one cutting insert 100 is secured in a way that allows for multiple cutting inserts 100 to be secured within the insert groove 160. In an embodiment, the at least one cutting insert 100 is secured within the insert groove 160 by a dial screw. In another embodiment, the at least one cutting insert 100 is secured by screwing together the cutting insert 100 and the insert groove 160.

The cutting insert 100 has a cutting surface 164 and a bottom surface 166. The cutting surface 164 is the part of the boring head body 142 that actually performs the boring. The cutting insert 100 is any shape that allows the cutting surface 164 to bore long deep holes with flat bottoms. In an embodiment, the cutting insert 100 is rectangular in shape and the cutting surface 164 is spherical. The cutting surface 164 extends to a third length 106. The third length 106 is measured as the distance between the lowest point of the bottom surface 166 and the highest point of the cutting surface 164. In an embodiment, the third length 106 is greater than the first length 112. Alternative embodiments may have other lengths.

While it is not explicitly shown, it is to be appreciated that the cutting insert 100 can be one solid component or it can be comprised of multiple components secured together. If comprised of multiple components, the components would include a cutting surface 164 and a bottom surface 166. For example, in an embodiment, the cutting insert 100 can be comprised of bottom surface 166 that can be secured to different cutting surfaces 164. In an embodiment, the different cutting surfaces 164 accommodate boring different materials with one bottom surface 166. In another embodiment, the different cutting surfaces 164 provide different finishes with one bottom surface 166.

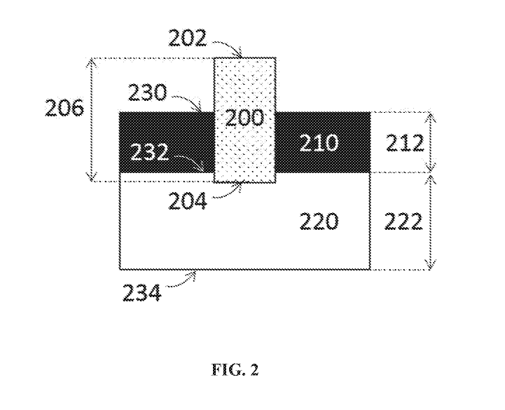

FIG. 2 is a section view of an embodiment of the present invention illustrating the different lengths of the present invention. The first length 212 spans the distance from highest point 232 of the low plane 220 and the highest point 230 of the high plane 210. The second length 222 spans the distance from the lowest point of the attachment face 234 to the highest point 232 of the low plane 220. The cutting insert's 200 third length 206 spans the distance between the lowest point of the bottom surface 204 and the highest point of the cutting surface 202.

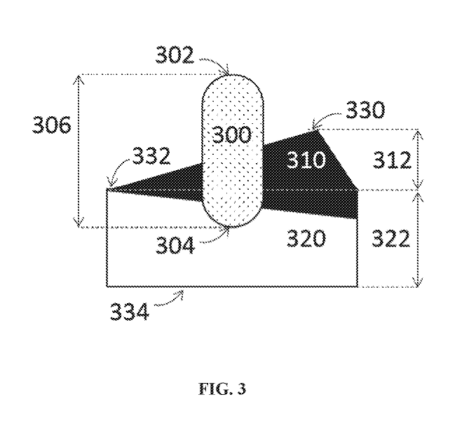

FIG. 3 is a section view of an embodiment of the present invention illustrating the different lengths of the present invention. The first length 312 spans the distance from highest point 332 of the low plane 320 and the highest point 330 of the high plane 310. The second length 322 spans the distance from the lowest point of the attachment face 334 to the highest point 332 of the low plane 320. The cutting insert's 300 third length 306 spans the distance between the lowest point of the bottom surface 304 and the highest point of the cutting surface 302.

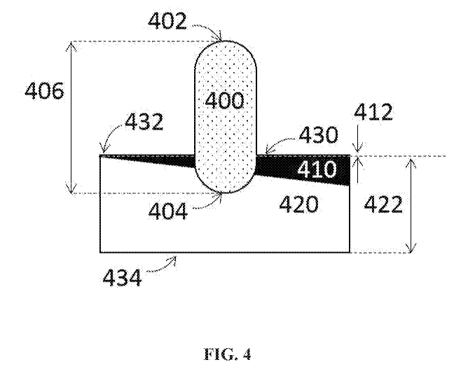

FIG. 4 is a section view of an embodiment of the present invention illustrating the different lengths of the present invention. The first length 412 spans the distance from highest point 432 of the low plane 420 and the highest point 430 of the high plane 410, in this embodiment the first length 412 is zero. The second length 422 spans the distance from the lowest point of the attachment face 434 to the highest point 432 of the low plane 420. The cutting insert's 400 third length 406 spans the distance between the lowest point of the bottom surface 404 and the highest point of the cutting surface 402.

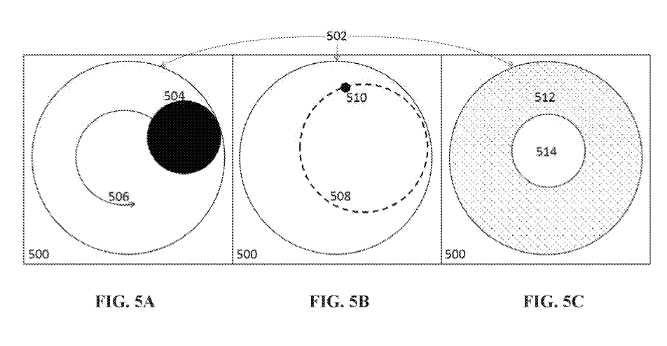

Unlike prior art boring bar heads, the cutting surface of the boring bar head according to the invention can reach the perimeter and the center of a deep hole. FIGS. 5A-5C are plan views of typical prior art boring bar heads that are unable to reach the perimeter and center of a deep hole. FIG. 5A shows the boring bar head 504 travels in a circular path 506 on and within the part being bored 500 creating hole 502. FIG. 5B shows the path 508 the cutting insert 510 travels on and within the part being bored 500. FIG. 5C is a plan view of the concentric circles 512 created with multiple rotations of the typical prior art boring bar head 504. The prior art bore head 504 is unable to reach both the center and perimeter of the hole 502 leaving area 514 that is untouched by the boring bar head 504. Accordingly the typical prior art boring bar head 504 is unable to bore a deep and flat bottomed hole.

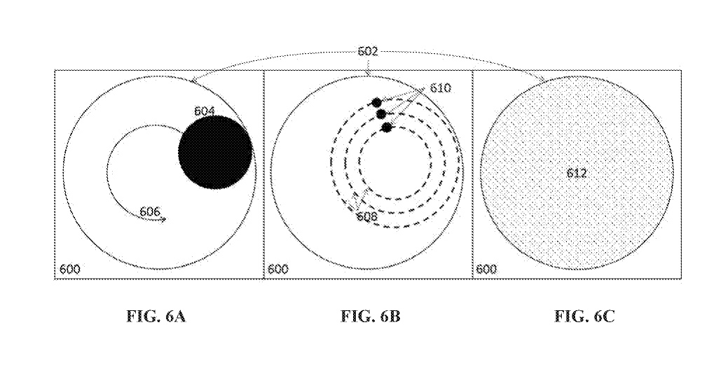

FIGS. 6A-6C are plan views of an embodiment of the present invention's cutting path. FIG. 6A shows the boring bar head 604 travels in a circular path 606 on and within the part being bored 600 creating hole 602. FIG. 6B shows the concentric circular paths 608 the three cutting inserts 610 travel on and within the part being bored 600. The multiple cutting inserts 610 make multiple rotations within the part being bored 600. If one cutting insert 610 is used, cutting path 608 is created by moving the cutting insert 610 to different positions and making additional rotations with the present invention's boring bar head 604. If multiple cutting inserts 610 are used, cutting path 608 is created with one rotation of the present invention's boring bar head 604. FIG. 6C is a plan view of the concentric circles created with multiple rotations of an embodiment of the present invention's boring bar head 604 that reach the perimeter and center of the deep hole 612. Accordingly the boring bar head 604 of the present invention is able to bore a deep and flat bottomed hole.

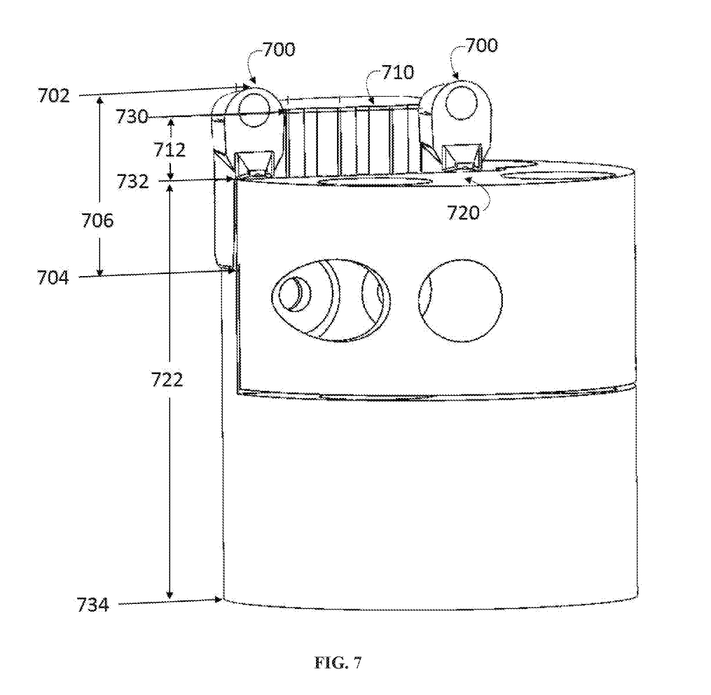

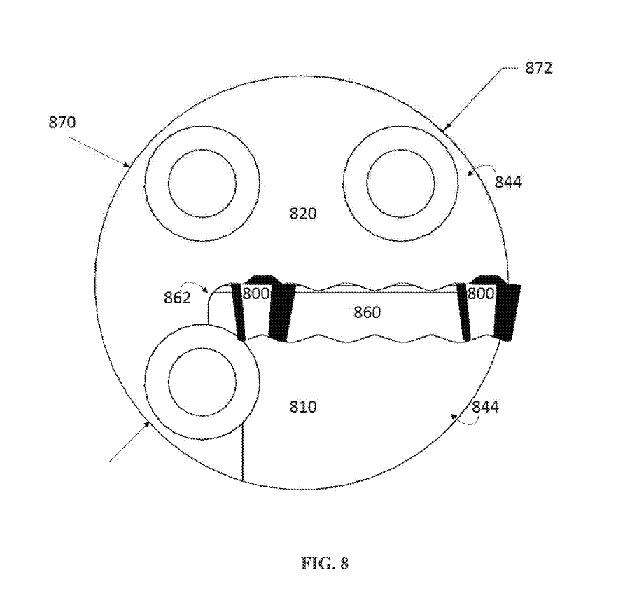

FIG. 7 is a side isometric view of an embodiment of the present invention. The first length 712 spans the distance from highest point 732 of the low plane 720 and the highest point 730 of the high plane 710 and is 0.473 inches. The second length 722 spans the distance from the lowest point of the attachment face 734 to the highest point 732 of the low plane 720 and is 1.30 inches. The two cutting inserts' 700 third length 706 spans the distance between the lowest point of the bottom surface 704 and the highest point of the cutting surface 702 and is 0.561 inches. FIG. 8 is a top isometric view of an embodiment of the present invention. The front face 844 has a perimeter 870 and a diameter 872. The diameter 872 measures 1.25 inches. The insert groove 860 is disposed between the high plane 810 and low plane 820. There are two cutting inserts 800 within the insert groove 860, and a cutting insert groove end point 862.

It is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements.

Any element in a claim that does not explicitly state “means for” performing a specified function, or “step for” performing a specific function, is not to be interpreted as a “means” or “step” clause as specified in 35 U.S.C. § 112, ¶6. In particular, the use of “step of” in the claims herein is not intended to invoke the provisions of 35 U.S.C. § 112, ¶6.

We claim:

1. A boring bar head body comprising:
a front face, an attachment face opposed to the front face, an axis such that boring bar head body can be rotated around the axis;
the attachment face operably connected to a boring bar;
the front face having a low plane and a high plane, an insert groove disposed between at least a portion of the high and low planes, at least one cutting insert disposed in the insert groove;
the high and low planes disposed substantially orthogonal to the axis;
the high plane having a first length;
the low plane having a second length;
the at least one cutting insert having a cutting surface and a bottom surface, the cutting surface extends to a third length; and
the at least one cutting insert is removably attached to the insert groove.

2) The boring bar head body of claim 1 wherein the axis is substantially perpendicular to the front face and attachment face.

3) The boring bar head body of claim 1 wherein the attachment face connects to the boring bar with a dial screw.

4) The boring bar head body of claim 1 wherein the attachment face connects to the boring bar with a dovetail joint.

5) The boring bar head body of claim 1 wherein the third length is greater than the first length.

6) The boring bar head body of claim 1 wherein the first length is shorter than the second length.

7) The boring bar head body of claim 1 wherein the first length is zero.

8) The boring bar head body of claim 1 wherein the low plane is parallel to high plane.

9. The boring bar head body of claim 1 wherein the insert groove extends radially inward towards and past the axis.

10) The boring bar head body of claim 1 wherein the insert groove traverses along a chord.

11) The boring bar head body of claim 1 wherein three cutting inserts are disposed in the insert groove.

12) The boring bar head body of claim 1 wherein the first length is 0.473 inches, the second length is 1.30 inches, and the third length is 0.561 inches.

13) The boring bar head body of claim 1 where the diameter of the front face is 1.25 inches.

14) The boring bar head body of claim 1 wherein the cutting insert comprises connected components.
